(19) United States
(12) Patent Application Publication
(10) Pub. No.: US 2007/0153050 A1
(43) Pub. Date: Jul. 5, 2007

(54) Apparatus and method for ink-jetting

(75) Inventors: Jin-koo Chung, Gyeonggi-do (KR); Dong-won Lee, Gyeonggi-do (KR); Song-mi Hong, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/647,996

(22) Filed: Dec. 29, 2006

(30) Foreign Application Priority Data
Dec. 29, 2005 (KR) 2005-0134256

(51) Int. Cl. B41J 2/165

(52) U.S. Cl. 347/29

(57) ABSTRACT

An inkjet apparatus comprising a stage which has a seating area on which a substrate is seated; a plurality of nozzle heads having a plurality of nozzles disposed in a first direction; an ink supply which jets ink through the nozzle heads; a driver which moves the nozzle heads in a first direction relative to the stage and in a second direction which is perpendicular to the first direction; and a nozzle maintenance part which is located on a circumferential part of the seating area.

### CROSS-REFERENCE TO RELATED APPLICATIONS

This application claims the benefit of Korean Patent Application No. 2005-0134256, filed on Dec. 29, 2005, in the Korean Intellectual Property Office, the disclosure of which is incorporated herein by reference.

### FIELD OF THE INVENTION

The present invention relates to an apparatus and a method for ink-jetting, and more particularly, to an inkjet apparatus which comprises a nozzle maintenance part to efficiently maintain the performance of a nozzle head, and an ink-jetting method.

### DESCRIPTION OF THE RELATED ART

Flat panel displays such as the liquid crystal display (LCD) and the organic light emitting diode (OLED) display have become widely used as replacements for cathode ray tube displays. The flat panel display comprises several organic layers such as a color filter layer, an organic semiconductor layer, a light emitting layer and an alignment film which are generally deposited by an inkjet method. The organic layers are formed through the inkjet method without need for exposure, development and etching processes. A plurality of nozzle heads are used for producing a large-sized substrate to reduce the processing time. The plurality of nozzle heads is mounted to a head main body to move along therewith. Some of the nozzle heads may not be used during the ink-jetting process when the plurality of nozzle heads is employed. When the nozzle heads do not jet ink, the nozzles may be clogged or lowered in performance.

### SUMMARY OF THE INVENTION

An inkjet apparatus comprising a stage which has a seating area on which a substrate is seated; a plurality of nozzle heads which respectively have a plurality of nozzles and disposed in a first direction; an ink supply which jets ink through the nozzle heads; a driver which moves the nozzle heads and the stage relatively in a first direction and in a second direction perpendicular to the first direction; and a nozzle maintenance part which is located on a circumferential part of the area in the second direction.

According to another aspect of the present invention, the nozzle maintenance part comprises at least one spittoon which accommodates surplus jetted ink, a capping station which accommodates a solvent, and a blotting stage which has an absorbing member. Advantageously, the nozzle maintenance part comprises one or more parts that move together with the stage at the side of the seating area and a part thereof may protrude in a first direction outside the stage to an extent longer than the nozzle heads.

According to another aspect of the present invention, the inkjet apparatus further comprises an additional nozzle maintenance part which is disposed on the circumferential part of the stage in the first direction.

According to another aspect of the present invention, the driver comprises a first sub driver which moves the nozzle heads in a first direction, and a second sub driver which moves the stage in a second direction.

An inkjet method of the invention comprises seating a substrate on a stage; moving a plurality of nozzle heads having a plurality of nozzles arranged in a first direction, with respect to the stage in the first direction and in a second direction perpendicular to the first direction, and jetting ink; and moving the nozzle heads onto a nozzle maintenance part which is provided on a circumferential part of the substrate in the second direction.

### BRIEF DESCRIPTION OF THE DRAWINGS

The above and/or other aspects and advantages of the present invention will become apparent and more readily appreciated from the following description of the embodiments, taken in conjunction with the accompany drawing, in which:

FIG. 1 is a perspective view of an inkjet apparatus according to a first embodiment of the present invention;

FIGS. 2a and 2b illustrate a nozzle head of the inkjet apparatus according to the first embodiment of the present invention;

FIG. 3 is a control block diagram of the inkjet apparatus according to the first embodiment of the present invention;

FIG. 4 illustrates the inkjet apparatus according to the first embodiment of the present invention, which mounts a substrate therein;

FIG. 5 illustrates an equivalent circuit of a pixel in a display apparatus which is manufactured according to the present invention;

FIG. 6 is a sectional view of the display apparatus manufactured according to the present invention;

FIGS. 7 through 11 illustrate a manufacturing method of the display apparatus according to the present invention;

FIG. 12 illustrates an inkjet apparatus according to a second embodiment of the present invention;

FIGS. 13a and 13b illustrate an inkjet apparatus according to a third embodiment of the present invention;

FIGS. 14 through 16 illustrate inkjet apparatuses according to fourth to sixth embodiments of the present invention, respectively.

### DETAILED DESCRIPTION OF EMBODIMENTS

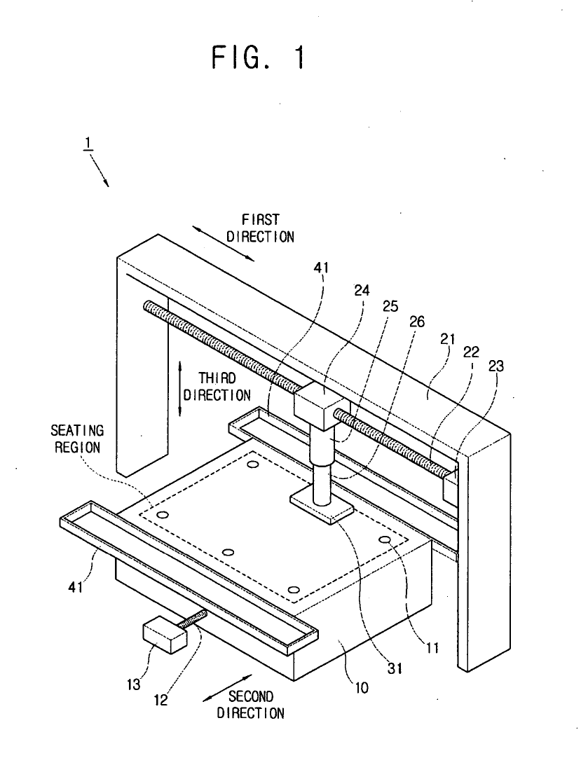

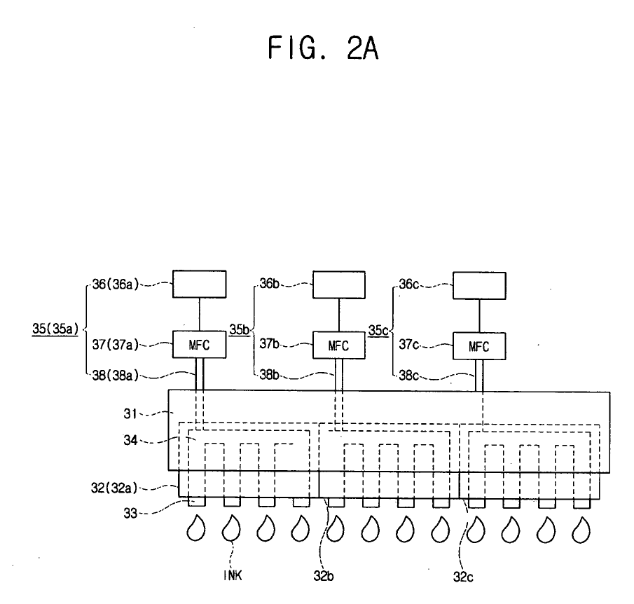

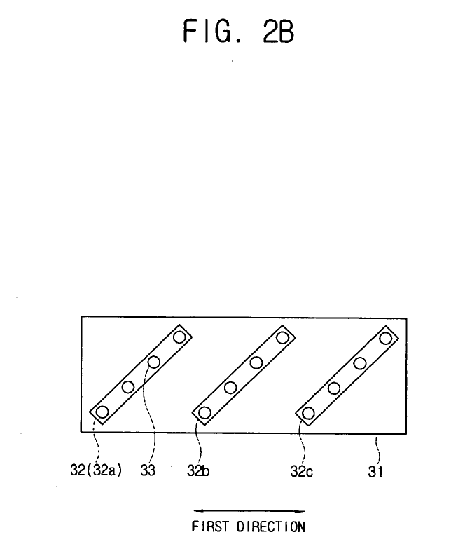

FIG. 1 is a perspective view of the inkjet apparatus according to the first embodiment of the present invention. FIGS. 2a and 2b illustrate a nozzle head of the inkjet apparatus according to the first embodiment of the present invention.

An inkjet apparatus 1 comprises a stage 10 on which a substrate is stably seated; a nozzle head 32 which is provided on stage 10 and has a nozzle 33 to jet ink; and a pair of spittoons 41 which are provided on a circumferential part of stage 10.

The nozzle head 32 and stage 10 move relative to each other in a first direction and a second direction which are perpendicular to each other. The inkjet apparatus 1 is connected with the nozzle head 32. The inkjet apparatus 1 further comprises a first driver 23 which is connected with the nozzle head 32 to move in the first direction; and a second driver 13 which is connected with stage 10 to move in the second direction.

Stage 10 has a rectangular shape and comprises a seating area on which the substrate is stably seated to form an organic layer thereon by jetting ink. Stage 10 further comprises a vacuum chuck 11 to attach the seated substrate to the seating area, but not limited thereto. Alternatively, the substrate can be attached through other units such as an electrostatic chuck.

Stage 10 is connected with the second driver 13 through a second rotation screw 12. The second rotation screw 12 rotates clockwise or counterclockwise according as the second driver 23 operates. Stage 10 reciprocates in the second direction which is parallel with a short side of stage 10 as the second rotation screw 12 rotates. The second driver 13 may comprise a motor.

The inkjet apparatus 1 may further comprise a rail (not shown) to move stage 10 without difficulty.

Stage 10 may comprise a supporting main body 21 which has a □-shape and supports a head main body 31. A plurality of nozzle heads 32 is mounted to head main body 31. The supporting main body 21 is extended in a direction which is perpendicular to the second direction.

The supporting main body 21 comprises a first rotation screw 22. A first end of the first rotation screw 22 is rotatably coupled with a first side of the supporting main body 21, and a second end thereof is coupled with the first driver 23 which is attached to a second side of the supporting main body 21. The first rotation screw 22 is coupled with a rotation shaft connector 24 which has a female screw. The rotation shaft connector 24 reciprocates in the first direction according to the rotation of the first rotation screw 22.

Head main body 31 connected with the rotation shaft connector 24 reciprocates according to the movement of the rotation shaft connector 24. As the first rotation screw 22 is extended in a direction perpendicular to the second direction, the moving direction of head main body 31 is perpendicular to that of stage 10.

Head main body 31 is connected with the rotation shaft connector 24 through a third driver 25 and an intermediate connector 26. The third driver 25 is retracted and extended, thereby reciprocating head main body 31 in a third direction perpendicular to a plate surface of stage 10. Accordingly, head main body 31 may be adjacent to/spaced from stage 10.

The configuration for moving stage 10 and head main body 31 is described above as an exemplary embodiment of the present invention, but not limited thereto. The present invention may applicable to various configurations as long as they move relative to stage 10 and head main body 31.

Nozzle heads 32 will be described in detail with reference to FIGS. 2a and 2b. FIG. 2b illustrates head main body 31 having nozzle heads 32 therein, which is viewed from stage 10.

Head main body 31 has a rectangular shape which is elongated in a first direction. The nozzle heads comprise three sub nozzle heads 32a, 32b and 32c which are mounted to head main body 31 along the first direction. The respective nozzle heads 32 extend to form a predetermined angle with respect to the first direction. The angle may be adjusted according to intervals of an ink-jetted object.

Nozzle heads 32 respectively comprise four nozzles 33 which are mounted in a row and which receive ink from ink supply 35. Ink supply 35 comprises an ink tank 36 which stores ink; a mass flow controller 37 which controls the mass flow of ink; and a pipe 38 which connects the ink tank 36 and head main body 31. Ink supply 35 comprises three sub ink supplies 35a, 35b and 35c. The sub ink supplies 35a, 35b and 35c supply ink to the sub nozzle heads 32a, 32b, and 32c, which are connected therewith respectively. The ink tank 36, the mass flow controller 37 and the pipe 38 respectively comprise three sub ink tanks 36a, 36b and 36c, three sub mass flow controllers 37a, 37b and 37c, and three sub pipes 38a, 38b and 38c.

The sub ink supplies 35a, 35b and 35c may supply like or different ink.

Ink which is supplied to head main body 31 through the pipe 38 is transmitted to/jetted through the nozzle 33 through a flow path 34 which is provided between head main body 31 and nozzle heads 32.

Returning to FIG. 1, a pair of spittoons 41 are provided on a circumferential part of stage 10. Spittoons 41 are shaped like a vessel and accommodate ink to be jetted, but not limited thereto. Alternatively, spittoons 41 may comprise a cloth to absorb jetted ink. When ink is not jetted from nozzles 33, nozzles 33 may be clogged or lowered in performance. Thus, head main body 31 is positioned on spittoons 41 and jets ink to spittoons 41 during the jetting standby time, e.g., when replacing an ink-jetted substrate.

Spittoons 41 are elongated in a first direction and provided at either side of stage 10. Spittoons 41 are attached to and reciprocate with stage 10 in the second direction. The ends of spittoons 41 protrude beyond the outside edges of stage 10.

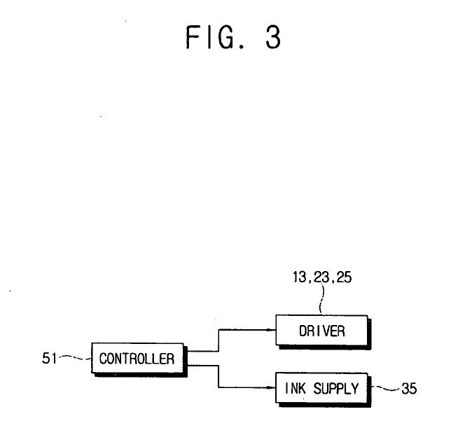

FIG. 3 is a control block diagram of the inkjet apparatus 1 according to the first embodiment of the present invention. A controller 51 controls drivers 13, 23 and 25 to adjust the intervals between stage 10 and head main body 31 and to position head main body 31 with respect to spittoons 41. Controller 51 controls ink supply 35 to jet ink through nozzles 33 or to stop jetting ink and also controls the sub ink supplies 35a, 35b and 35c thereby allowing some of nozzle heads 32 to jet ink and others to stop jetting ink.

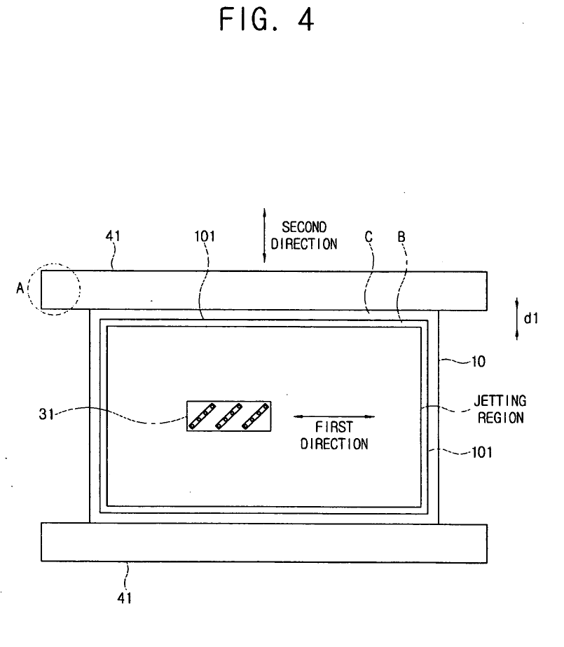

FIG. 4 illustrates inkjet apparatus 1 with a substrate 101 located on the seating area to be jetted by ink. Substrate 101 typically may be used in a display apparatus such as an organic light emitting diode (OLED) or a liquid crystal display (LCD). An organic semiconductor layer, a light emitting layer, a color filter layer and an alignment film may be formed on the substrate 101 by jetting ink. When the substrate 101 is used in the display apparatus, the jetting area may correspond to a display area.

Opposite ends “A” of spittoons 41 protrude to the outside stage 10. A regular interval “dl” exists between the jetting area and spittoons 41, and comprises a non-display area “B” which is not jetted by ink; and a circumferential part “C” of the seating area in stage 10.

The first embodiment of the present invention can be variously changed. For example, ink supply 35 may further comprise an on/off valve which is disposed between the ink tank 36 and head main body 31. Here, the controller 51 may turn off the valve which is connected with the nozzle head 32 to stop jetting ink.

Ink supply 35 may further comprise an ink tank which is adjustable in pressure and the jetting ink through the nozzle 33 can be achieved by adjusting the pressure of the ink tank.

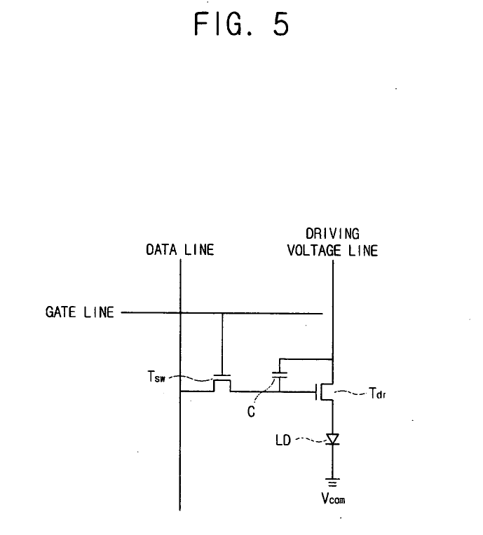

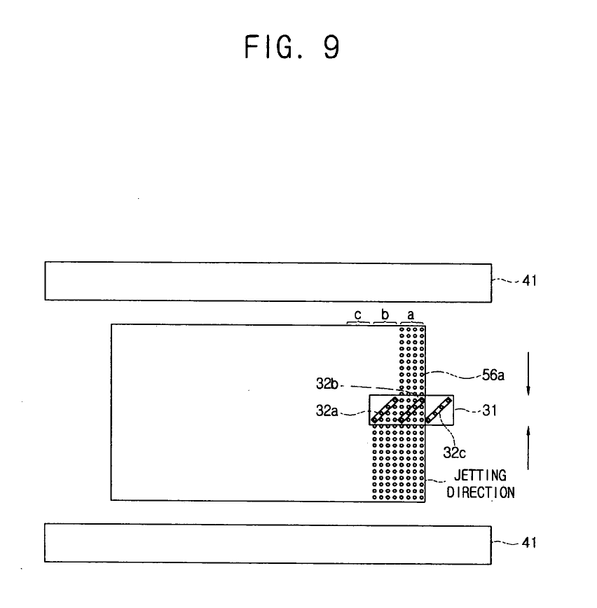

Hereinafter, a method of manufacturing the display apparatus which employs the inkjet apparatus according to the first embodiment of the present invention will be described with reference to FIGS. 5 through 12. Here, an organic light emitting diode (OLED) is provided as an exemplary embodiment of the display apparatus, and an organic light emitting layer forming process is provided as an example of the ink-jetting process, but not limited thereto. Alternatively, the present invention may be applicable to various display apparatuses and organic layers.

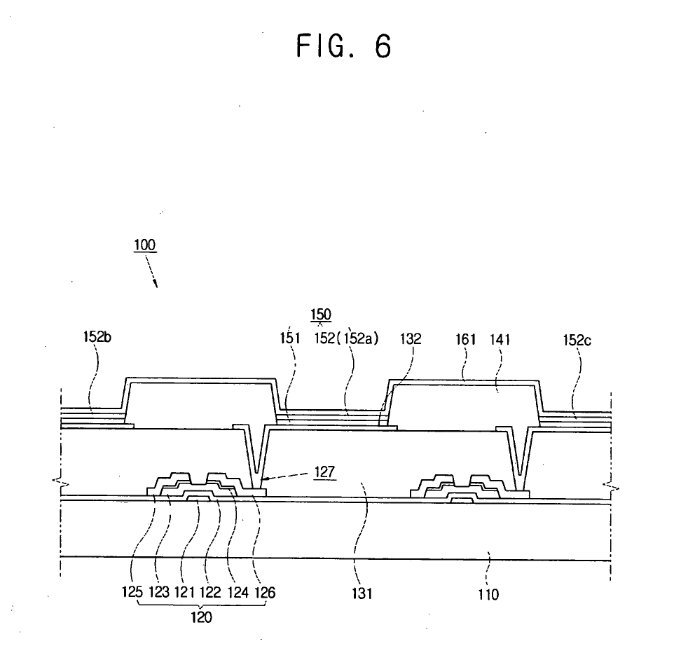

First, the display apparatus which is manufactured according to the present invention will be described with reference to FIGS. 5 and 6.

FIG. 5 is an equivalent circuit of a pixel in the display apparatus manufactured according to the present invention.

A single pixel comprises a plurality of signal lines. The signal lines comprise a gate line which transmits a scanning signal; a data line which transmits a data signal; and a driving voltage line which transmits a driving voltage. The data line is adjacent to the driving voltage line and in parallel therewith. The gate line is extended and perpendicular to the data line and the driving voltage line.

Each pixel comprises an organic light emitting device (LD); a switching thin film transistor Tsw; a driving thin film transistor Tdr and a capacitor (C).

The driving thin film transistor Tdr comprises a control terminal, an input terminal and an output terminal. The control terminal thereof is connected with the switching thin film transistor Tsw, the input terminal is connected with the driving voltage line, and the output terminal is connected with the organic light emitting device (LD).

The organic light emitting device (LD) comprises an anode which is connected with the output terminal of the driving thin film transistor Tdr; and a cathode which is connected with a common voltage Vcom. The organic light emitting device (LD) emits light in different levels according to an output current of the driving thin film transistor Tdr, to display an image. The current of the driving thin film transistor Tdr depends on the voltage between the control terminal and the output terminal.

The switching thin film transistor Tsw comprises a control terminal, an input terminal and an output terminal. The control terminal thereof is connected with the gate line, the input terminal is connected with the data line and the output terminal is connected with the control terminal of the driving thin film transistor Tdr. The switching thin film transistor Tsw transmits the data signal supplied to the data line according to the scanning signal supplied to the gate line, to the driving thin film transistor Tdr.

The capacitor (C) is connected between the control terminal and the input terminal of the driving thin film transistor Tdr. The capacitor (C) charges and maintains the data signal that is input to the control terminal of the driving thin film transistor Tdr.

FIG. 6 is a sectional view of the display apparatus which is manufactured according to the present invention.

A display apparatus 100 which is manufactured according to the present invention comprises a thin film transistor 120 which is formed on an insulating substrate 110; a pixel electrode 132 which is electrically connected with the thin film transistor 120; and an organic layer 150 which is formed on the pixel electrode 132.

FIG. 6 illustrates the thin film transistor 120 which comprises amorphous silicon, but not limited thereto. Alternatively, the thin film transistor 120 may comprise poly silicon.

Hereinafter, the display apparatus 100 manufactured according to the present invention will be described in detail.

A gate electrode 121 is formed on the insulating substrate 110 which is made of an insulating material such as glass, quartz, ceramic or plastic.

A gate insulating film 122 which is made of silicon nitride (SiNx) is formed on the insulating substrate 110 and the gate electrode 121. A semiconductor layer 123 comprising amorphous silicon and an ohmic contact layer 124 comprising n+ amorphous hydrogenated silicon highly doped with an n-type dopant are sequentially formed on the gate insulating film 122 corresponding to the gate electrode 121. Here, the ohmic contact layer 124 is separated into two parts with respect to the gate electrode 121.

A source electrode 125 and a drain electrode 126 are formed on the ohmic contact layer 124 and the gate insulating film 122. Further, the source electrode 125 and the drain electrode 126 are separated with respect to the gate electrode 121.

A passivation film 131 is formed on the source electrode 125, the drain electrode 126 and the semiconductor layer 123 exposed between the source and drain electrodes 125 and 126. The passivation film 131 may be made of silicon nitride (SiNₓ) and/or an organic material. A contact hole 127 is formed on the passivation film 131 to expose the drain electrode 126.

The pixel electrode 132 is formed on the passivation film 131. The pixel electrode 132 is referred to as an anode, and supplies a hole to an organic light emitting layer 152. The pixel electrode 132 comprises a transparent conductive material such as indium tin oxide (ITO), indium zinc oxide (IZO) and formed by a sputtering method. The pixel electrode 132 may be patterned as a rectangle, seen from a plate surface.

A partition wall 141 is formed between the pixel electrodes 132. The partition wall 141 divides the pixel electrodes 132 and defines a pixel area. The partition wall 141 is formed on the thin film transistor 120 and the contact hole 127. The partition wall 141 prevents the source electrode 125 and the drain electrode 126 of the thin film transistor 120 from being short-circuited with the common electrode 161. The partition wall 141 may be made of a photosensitive material such as acrylic resin, or polyimide resin which has heat resistance and solvent resistance; or an inorganic material such as SiO₂, and TiO₂. Further, the partition wall 141 may comprise a double structure having an organic layer and an inorganic layer.

A hole injecting layer 151 and the organic light emitting layer 152 are formed on the pixel electrode 132.

The hole injecting layer 151 may comprise poly(3,4-ethylenedioxy thiophene)(PEDOT) and polystyrene sulfonic acid (PSS).

The organic light emitting layer 152 comprises a red light emitting layer 152a which emits red light; a green light emitting layer 152b which emits green light; and a blue light emitting layer 152c which emits blue light.

The organic light emitting layer 152 comprises a poly fluorene derivative; a (poly)paraphenylenevinylene derivative; a polyphenylene derivative; polyvinylcarbazole; and poly thiophene. Further, these polymer materials can be used by being doped with a perylene pigment; a rhodamine pigment; rubrene; perylene; 9,10-diphenylanthracene; tetraphenylbutadiene; Nail red; coumarine 6; Quinacridone, etc.

The hole transmitted from the pixel electrode 132 is combined with an electron supplied from a common electrode 161 in the organic light emitting layer 152, thereby creating an exciton and emitting light during a deactivation process of the exciton.

The common electrode 161 is provided on the partition wall 141 and the organic light emitting layer 152. The common electrode 161 is called a cathode and supplies electron to the organic light emitting layer 152. The common electrode 161 may be stacked with a calcium layer and an aluminum layer. Preferably, the calcium layer which has a low work function is disposed adjacent to the organic light emitting layer 152.

Lithium fluoride increases light emitting efficiency according to material of the organic light emitting layer 152, and thus a lithium fluoride layer may be formed between the organic light emitting layer 52 and the common electrode 161. When the common electrode 161 is made of an opaque material such as aluminum or silver, light emitted from the organic light emitting layer 152 is transmitted to the insulating substrate 110 which is called a bottom emission type.

The display apparatus 100 may further comprise an electron transfer layer (not shown) and an electron injection layer (not shown) which are disposed between the organic light emitting layer 152 and the common electrode 161. The display apparatus 100 may further comprise an encapsulation member which prevents moisture and air from being penetrated to the organic layer 150 and/or another passivation film to protect the common electrode 161. The encapsulation member may comprise sealing resin and a sealing can.

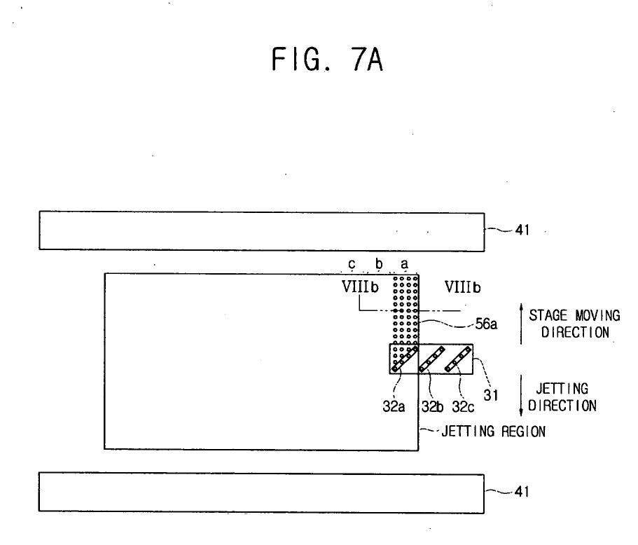

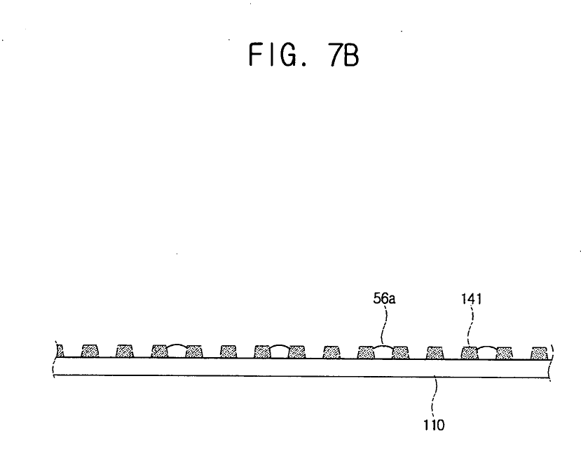

Hereinafter, a method of manufacturing the display apparatus according to the present invention will be described with reference to FIGS. 7 through 12.

Referring to FIGS. 7a and 7b, the substrate 101 is seated on stage 10 and a red light emitting ink 56a having a red light emitting material is jetted on the substrate 101. Here, the substrate 101 comprises the hole injecting layer 151 which is made by a well-known method.

After completing the ink-jetting for the red light emitting layer 152a, another ink-jetting operation is performed for a green light emitting layer 152b, followed by another ink-jetting operation for the blue light emitting layer 152c, but not limited thereto. The ink-jetting operation for the red light emitting layer 152a is provided as an exemplary embodiment of the present invention.

A plurality of sub jetting areas a, b, c are disposed on the jetting area, corresponding to one of the sub nozzle heads 32a, 32b and 32c. FIGS. 7a and 7b illustrate the sub jetting area (a) which is disposed in the far right and jetted with ink through the sub nozzle head 32a.

The sub ink tanks 36a, 36b and 36c of the sub ink supplies 35a, 35b and 35c store different ink therein with each other. That is, the sub ink supplies 35a, 35b and 35c supply ink which comprise a different colored light emitting material. The red light emitting ink 56a is stored in the sub ink tank 36a connected with the sub nozzle head 32a.

Ink is jetted while head main body 31 is stationary and stage 10 moves upwards. Accordingly, ink is jetted from top to bottom.

As shown in FIG. 7b, the red light emitting ink 56a is jetted to one of the three pixel electrodes 132. The remaining pixel electrodes 132 is jetted with ink having a light emitting material which emits different colored light, after completing the ink-jetting operation of the red light emitting ink 56a for the entire jetting area.

As the sub nozzle head 32a disposed in the left is used alone to form the red light emitting ink 56a, jetting is not performed by the remaining sub nozzle heads 32b and 32c.

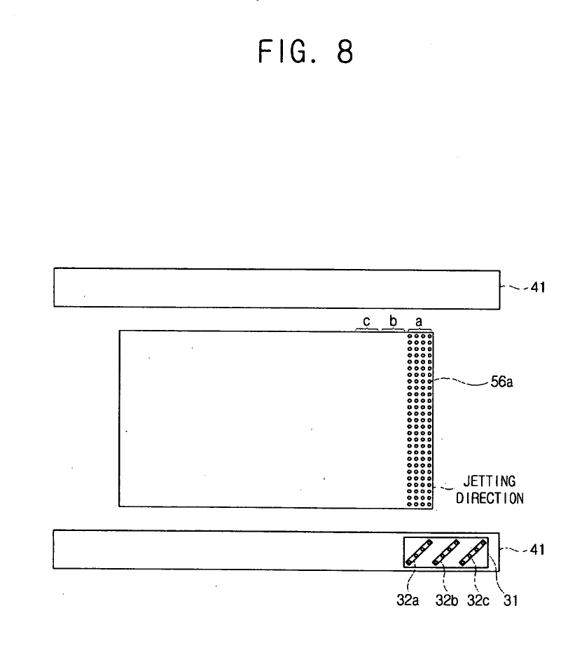

FIG. 8 illustrates head main body 31 which is disposed on the lower spittoon 41 after completing the ink-jetting of the red light emitting ink 56a for the sub jetting area (a) positioned in the far right.

After the ink-jetting operation of the sub jetting area (a) is completed, stage 10 further moves upwards. It does not take much time to move stage 10, as the interval d1 (refer to FIG. 4) between the ink-jetting area and spittoons 41 is relatively short. The movement of stage 10 between the jetting area and spittoons 41 does not require accuracy like that in jetting ink, the movement speed of stage 10 may be increased. The jetting operation of the sub nozzle head 32a jetting the red light emitting ink 56a for the sub jetting area (a) is preferably stopped while stage 10 moves, to prevent pollution of the substrate 101 and equipments.

All nozzles 33 of the nozzle head 32 disposed above spittoons 41 jet ink. Thus, the performance of the sub nozzle heads 32b and 32c is maintained.

After the sub nozzle heads 32b and 32c jet ink, head main body 31 moves left by predetermined distance and ink is jetted on the next sub jetting area (b). The movement distance of head main body 31 corresponds to a width of the respective sub jetting areas a, b and c.

Here, jetting is performed through the sub nozzle head 32a which jets the red light emitting ink 56a. Stage 10 moves downwards and ink is jetted from bottom to top.

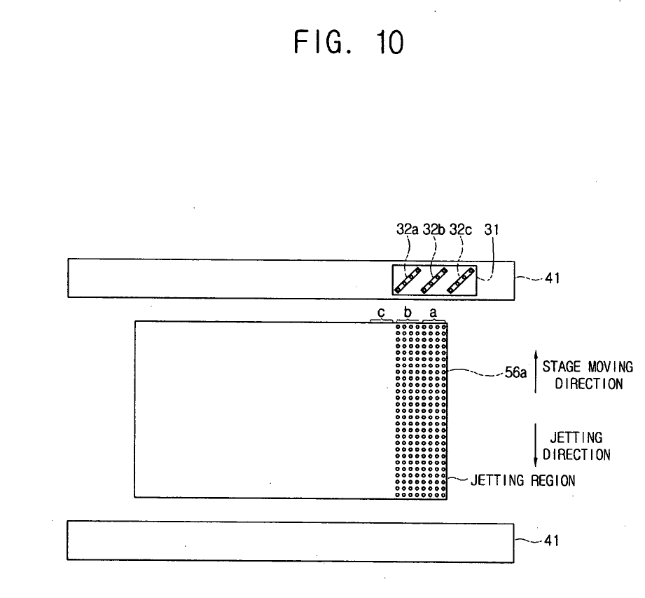

FIG. 10 illustrates head main body 31 which is disposed above the upper spittoon 41 and jets ink after completing the ink-jetting operation of the red light emitting ink 56a for the sub jetting area (b).

Accordingly, the performance of the sub nozzle heads 32b and 33b which have stopped jetting ink is maintained. With the foregoing process, the time while the sub nozzle heads 32b and 33c stop jetting ink may be limited to the ink-jetting time for one of the sub jetting areas a, b and c.

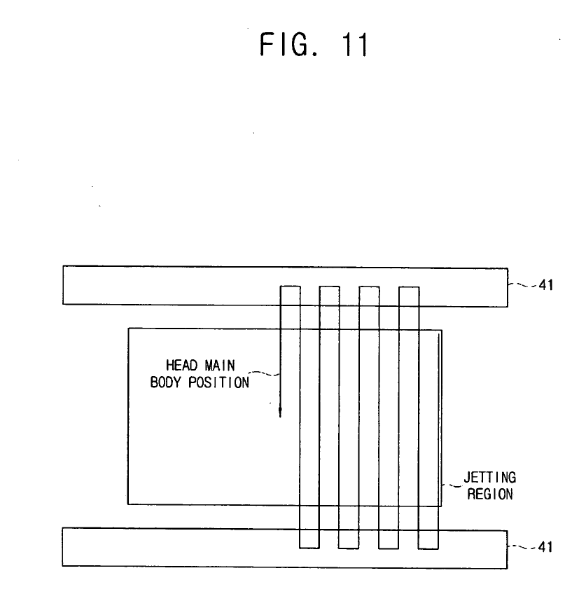

FIG. 11 illustrates the relative position of head main body 31 to the jetting area to explain the ink-jetting process which is described above.

FIG. 11 illustrates the position of head main body 31 for the red light emitting ink 56a alone. While jetting green light emitting ink and blue light emitting ink, the position of head main body 31 is similar, too.

As shown therein, head main body 31 moves in a zigzag pattern, reciprocating between the upper spittoon 41 and the lower spittoon 41. When head main body 31 is disposed within the jetting area, the red light emitting ink 56a is jetted through the sub nozzle head 32a while the remaining sub nozzle heads 32b and 32c stop jetting ink. When head main body 31 is disposed between the jetting area and spittoons 41, all the sub nozzle heads 32a, 32b and 32c stop jetting ink. When head main body 31 is disposed above spittoons 41, all the sub nozzle heads 32a, 32b and 32c jet ink. Alternatively, the sub nozzle heads 32b and 32c alone which have stopped jetting ink may jet ink when head main body 31 is disposed above spittoons 41.

With the foregoing process, the performance of the sub nozzle heads 32b and 32c which have stopped jetting ink with respect to the jetting area may be properly maintained. It does not take much time to move head main body 31 above spittoons 41, thereby hardly increasing the overall processing time.

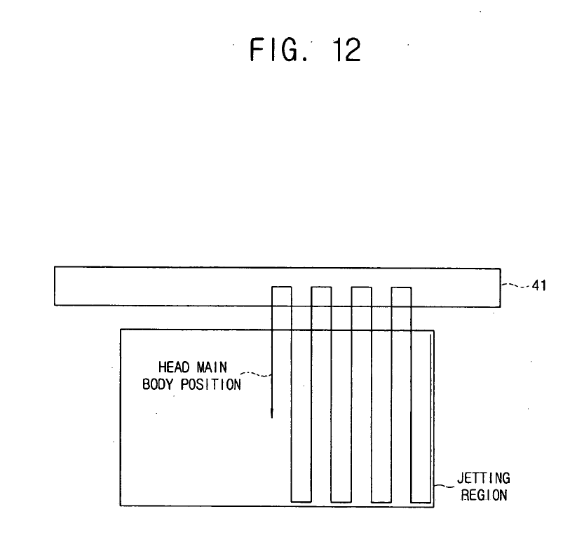

FIG. 12 illustrates an inkjet apparatus according to a second embodiment of the present invention.

A spittoon 41 according to the second embodiment of the present invention is solely provided. Thus, a head main body 31 moves to the spittoon 41 after jetting ink for two sub jetting areas. The jetting suspension time of sub nozzle heads 32b and 32c according to the second embodiment of the present invention becomes longer than that in the first embodiment while the processing time is reduced.

The inkjet apparatus according to the second embodiment of the present invention may be used in the case that a jetting area is small and jetting suspension time is short or in the case that the jetting suspension time to maintain the performance of a nozzle head is relatively long. Here, the jetting suspension time to maintain the performance of the nozzle head should be longer than the ink-jetting time for the two sub jetting areas.

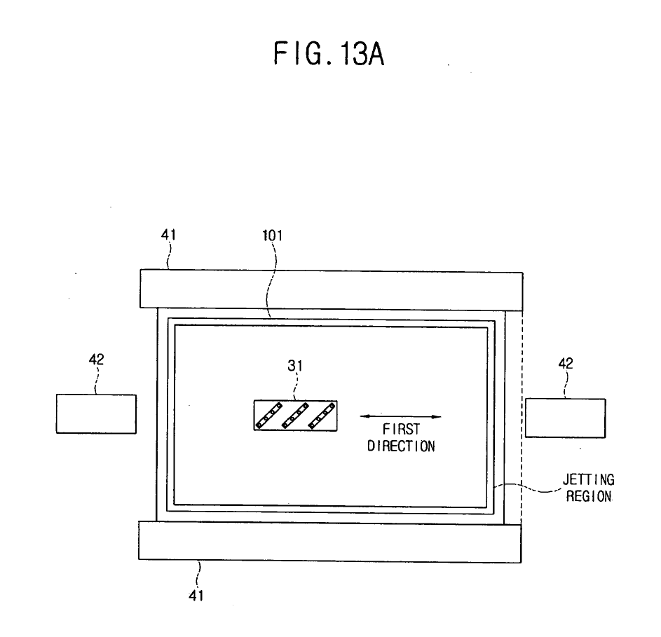

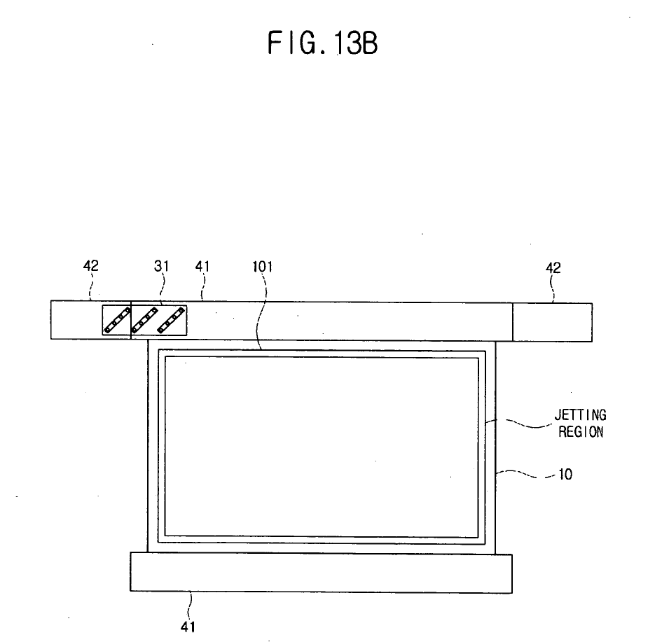

FIGS. 13a and 13b illustrate an inkjet apparatus according to a third embodiment of the present invention.

A pair of auxiliary spittoons 42 according to the third embodiment of the present invention are provided on opposite sides of a stage 10 in a first direction. Meanwhile, spittoons 41 are short in length when compared with the first and second embodiments. The auxiliary spittoons 42 are disposed below a first rotation screw 22. A head main body 31 moves in the first direction along the first rotation screw 22 to be positioned above the auxiliary spittoons 42. That is, the auxiliary spittoons 42 and head main body 31 are positioned in a straight line.

FIG. 13b illustrates the upper spittoon 41 and the auxiliary spittoons 42 disposed in a row as a stage 10 moves downwards. The upper spittoon 41 comes in contact with the auxiliary spittoons 42, thereby representing a similar pattern with the upper spittoon 41 according to the first embodiment of the present invention. When stage 10 moves upwards, the lower spittoon 41 comes in contact with the auxiliary spittoons 42.

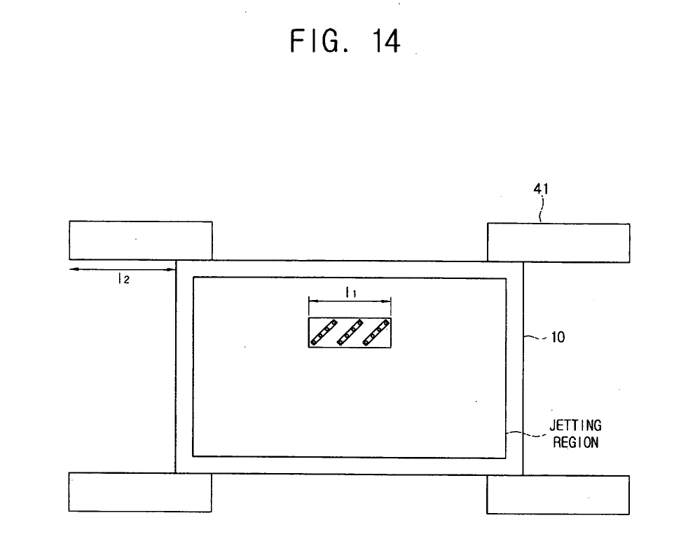

FIG. 14 illustrates an inkjet apparatus according to a fourth embodiment of the present invention.

Spittoons 41 according to the fourth embodiment of the present invention are disposed on four corners of a jetting area, respectively.

When all the pixel electrodes 132 are jetted with identical ink like a hole injecting layer 151, all the sub nozzle heads 32a, 32b and 32c jet ink to the jetting area. Here, the performance maintaining operation of a nozzle 33 may not carried out.

When a single sub jetting area has to be jetted with ink, a part of the sub nozzle heads 32a, 32b and 32c is positioned outside the jetting area to stop jetting ink. Spittoons 41 disposed at the four corners of the jetting area may be used to maintain the performance of the sub nozzle heads 32a, 32b and 32c which are disposed outside the jetting area.

A length 12 of spittoons 41 which protrude outside stage 10 is larger than a length 11 of a nozzle head 31. When the length 12 of the protruding spittoons 41 is shorter than the length 11 of the nozzle head 31, the position of the nozzle head 31 is not easily determined when positioning the nozzle head 31 outside stage 10 for a long time, e.g., when replacing the substrate 101.

The spittoon is provided as an exemplary embodiment of the nozzle maintenance part to maintain the performance of the nozzle head, but not limited thereto. Alternatively, a capping station or a blotting stage can be used instead of the spittoon.

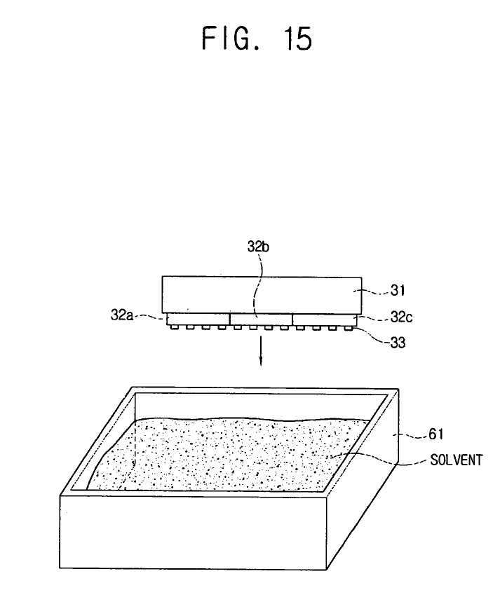

FIG. 15 illustrates a capping station 61 according to a fifth embodiment of the present invention, which is filled with a solvent. The capping station 61 is shaped like a vessel.

When a head main body 31 is disposed on the capping station 61, a nozzle 33 is dipped into the solvent of the capping station 61. Then, the solvent is introduced to inside the nozzle 33 to maintain the performance of the nozzle 33.

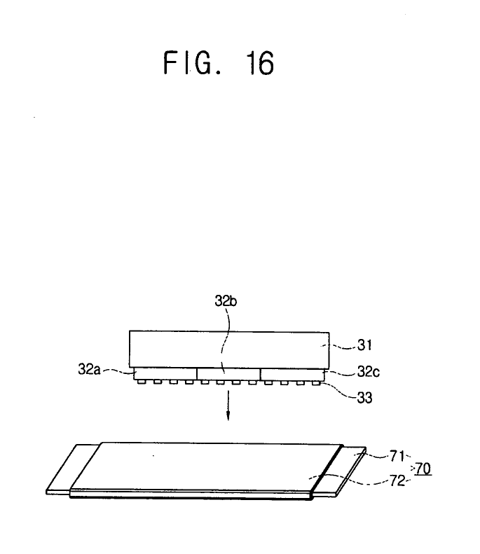

As shown in FIG. 16, a blotting stage 70 according to a sixth embodiment of the present invention comprises a bar member 71 and an absorbing member 72 which surrounds the bar member 71. The absorbing member 72 may comprise a cloth which absorbs ink.

After a head main body 31 moves to the blotting stage 70, a nozzle 33 is contacted with the absorbing member 72 of the blotting stage 70. The absorbing member 72 absorbs ink which is disposed in the nozzle 33 and thus ink is supplied to the nozzle 33 and maintains the performance of the nozzle 33.

The apparatus and the method for ink-jetting can be employed to manufacture a substrate for other display apparatuses, other than the organic light emitting diode.

For example, the present invention can be applicable to manufacture an organic thin film transistor substrate which uses an organic semiconductor as a semiconductor layer. The organic thin film transistor can be used in an organic light emitting diode (OLED) or a liquid crystal display (LCD).

The apparatus and the method for ink-jetting according to the present invention can be applicable to manufacture a color filter substrate, particularly in forming an alignment film using polyimide or in manufacturing a color filter layer.

As described above, the present invention provides an inkjet apparatus which reduces pollution due to ink.

Further, the present invention provides an inkjet method which reduces pollution due to ink.

Although a few embodiments of the present invention have been shown and described, it will be appreciated by those skilled in the art that changes may be made in these embodiments without departing from the spirit and scope of the invention.

What is claimed is:

1. An inkjet apparatus comprising:
a stage which has a seating area on which a substrate is seated;
a plurality of nozzle heads having a plurality of nozzles and disposing in a first direction;
an ink supply which jets ink through the nozzle heads;
a driver which moves the nozzle heads relative to the stage in the first direction and in a second direction which is perpendicular to the first direction; and
a nozzle maintenance part located on a circumferential part of the seating area in the second direction.

2. The inkjet apparatus according to claim 1, wherein the nozzle maintenance part comprises at least one spittoon which accommodates jetted ink, a capping station which accommodates a solvent, and a blotting stage which has an absorbing member.

3. The inkjet apparatus according to claim 1, wherein the nozzle maintenance part moves together with the stage.

4. The inkjet apparatus according to claim 1, wherein the nozzle maintenance part is provided at opposite ends of the seating area.

5. The inkjet apparatus according to claim 1, wherein the stage is rectangular, and wherein the nozzle maintenance part is disposed at a corner of the stage.

6. The inkjet apparatus according to claim 5, wherein the nozzle maintenance part is disposed at four corners of the seating area.

7. The inkjet apparatus according to claim 5, wherein the nozzle maintenance part is elongated along the first direction.

8. The inkjet apparatus according to claim 5, wherein a part of the nozzle maintenance part protrudes beyond the stage.

9. The inkjet apparatus according to claim 8, wherein the protruding part of the nozzle maintenance part is longer than the nozzle heads.

10. The inkjet apparatus according to claim 1, wherein the nozzle maintenance part is in contact with the stage.

11. The inkjet apparatus according to claim 1, the apparatus further comprising:
an additional nozzle maintenance part which is disposed on the circumferential part of the stage in the first direction.

12. The inkjet apparatus according to claim 10, wherein the additional nozzle maintenance part is provided as a pair, leaving the stage therebetween.

13. The inkjet apparatus according to claim 12, wherein the pair of the additional nozzle maintenance part and the nozzle heads are provided in a straight line.

14. The inkjet apparatus according to claim 11, wherein the nozzle maintenance part is in contact with the additional nozzle maintenance part when the stage and the nozzle heads move in the second direction.

15. The inkjet apparatus according to claim 1, wherein the driver comprises a first sub driver which moves the nozzle heads in the first direction, and a second sub driver which moves the stage in the second direction.

16. The inkjet apparatus according to claim 4, wherein the nozzle maintenance part is elongated along the first direction.

17. The inkjet apparatus according to claim 16, wherein a part of the nozzle maintenance part protrudes outside the stage along the first direction.

18. The inkjet apparatus according to claim 17, wherein the length of the nozzle maintenance part which protrudes outside is longer than that of the nozzle heads.

19. An inkjet method comprising:
seating a substrate on a stage;
moving a plurality of nozzle head with respect to the stage in a first direction and in a second direction perpendicular to the first direction, the plurality of nozzle heads having a plurality of nozzles and disposing in the first direction; and
moving the nozzle heads onto a nozzle maintenance part which is provided on a circumferential part of the substrate in the second direction.

20. The method according to claim 19, wherein the nozzle maintenance part comprises a spittoon which accommodates jetted ink, and the method further comprising jetting ink after moving the nozzle heads to the spittoon.

21. The method according to claim 19, wherein the nozzle maintenance part comprises a capping station which accommodates a solvent therein, and further comprising dipping the nozzle into the solvent after moving the nozzle heads to the capping station.

22. The method according to claim 19, wherein the nozzle maintenance part comprises a blotting stage which has an absorbing member, and further comprising contacting the nozzle with the absorbing member after moving the nozzle heads to the blotting stage.

23. The method according to claim 19, wherein the nozzle maintenance part moves together with the stage.
